(19) United States
(12) Patent Application Publication
(10) Pub. No.: US 2014/0289129 A1
(43) Pub. Date: Sep. 25, 2014

(54) METHOD FOR SECURE CONTACTLESS COMMUNICATION OF A SMART CARD AND A POINT OF SALE TERMINAL

(71) Applicant: iAXEPT Ltd, Surrey (GB)

(72) Inventors: Risto Kalevi SAVOLAINEN, Surrey (GB); Patrick-Gilles MAILLOT, Marsanne (FR)

(73) Assignee: iAXEPT Ltd, Surrey (GB)

(21) Appl. No.: 14/224,497

(22) Filed: Mar. 25, 2014

Related U.S. Application Data
(60) Provisional application No. 61/804,774, filed on Mar. 25, 2013.

(51) Int. Cl. G06Q 20/20; G06Q 20/34; G06Q 20/38

(52) U.S. Cl. CPC G06Q 20/20; G06Q 20/3829; G06Q 20/341
USPC 705/67

(57) ABSTRACT

The embodiment(s) relate to a method of securely communicating between a Point-of-Sale (PoS) terminal and a payment card. The method includes signing payment data with a private key of the PoS terminal to create a signature. The method includes encrypting the payment data and signature using a public key certificate of the payment card, which is encrypted and signed by a certificate authority using a certificate authority private key and is received at the PoS terminal after a public key certificate of the PoS terminal is validated at the payment card. The PoS terminal public key certificate is encrypted and signed by the certificate authority using the certificate authority private key. The method includes transmitting the encrypted payment data and signature to the payment card for decryption of the payment data and signature using a payment card private key corresponding to the payment card public key certificate.

### CROSS REFERENCE TO RELATED APPLICATIONS

This application is based on and claims priority to U.S. Provisional Patent App. No. 61/804,774, filed on Mar. 25, 2013 with the U.S. Patent Office, the contents of which priority application are hereby incorporated by reference in their entity.

### BACKGROUND OF THE INVENTION

1. Field of the Invention

The invention relates to a a smart card Point of Sale system which is based on a Public Key Infrastructure (PKI), and where the payment card is a smart card and the PoS terminal can communicate with the smart card and process payment transactions.

2. Description of the Related Art

Current smart card payment solutions based on Europay, Mastercard, and Visa (EMV) specification can be based on either contact or contactless communication between the smart card and the card reader, such as a Point of Sale (PoS) terminal. The EMV standard does not contain any data encryption for the communication between a smart card and a reader. In other words, the communication between an EMV smart card and an EMV card reader is clear text and containing all sensitive information including the card type, the card holder's name and the card account number.

When using contactless cards, this is causing a serious security problem. A person skilled in the art can easily build a card reader system which can using a contactless communication protocol, like Near Field Communication (NFC), to read someone else's NFC capable payment card information from a near proximity (1-20 cm), i.e. without touching or even seeing the card. This information can be used for online payments and for making ‘fake’ payment cards by copying the card information into an empty or used magnetic stripe card. This card could be used for fraudulent transactions.

### BRIEF SUMMARY OF THE INVENTION

The embodiment(s) describes a smart card Point-of-Sale (PoS) system which is based on a Public Key Infrastructure (PKI), and where the payment card is a smart card and the PoS terminal can communicate with the smart card and process payment transactions. The PoS terminal can be implemented as software residing in another or in the same smart card as the payment card. The software is configured to be used with and cause a processor or processing device to execute operations. This invention is not limited to contactless payment cards or EMV payment cards.

In one or more embodiments, a method of securely communicating between a Point-of-Sale (PoS) terminal and a payment card is provided. The method includes signing, at the PoS terminal, payment data with a private key of the PoS terminal to create a signature. The method also includes encrypting the payment data and the signature at the PoS terminal using a public key certificate of the payment card,. The payment card public key certificate is encrypted and signed by a certificate authority using a private key of the certificate authority and is received at the PoS terminal from the payment card after a public key certificate of the PoS terminal is received from the PoS terminal and validated at the payment card. The PoS terminal public key certificate is encrypted and signed by the certificate authority using the private key of the certificate authority. The method additionally includes transmitting the encrypted payment data and the encrypted signature to the payment card for decryption of the payment data and the signature at the payment card using a private key of the payment card corresponding to the payment card public key certificate.

In one or more embodiments, a method of securely communicating between a Point-of-Sale (PoS) terminal and a payment card is provided. The method includes signing, at the payment card, payment data with a private key of the payment card to create a signature. The method also includes encrypting the payment data and the signature at the payment card using a public key certificate of the PoS terminal. The PoS terminal public key certificate is encrypted and signed by a certificate authority using a private key of the certificate authority and is received at the payment card from the PoS terminal card after a public key certificate of the payment card is received from the payment card and validated at the PoS terminal. The PoS terminal public key certificate is encrypted and signed by the certificate authority using the private key of the certificate authority. The method additionally includes transmitting the encrypted payment data and the encrypted signature to the PoS terminal for decryption of the payment data and the signature at the PoS terminal using a private key of the PoS terminal corresponding to the PoS terminal public key certificate.

In one or more embodiments, a method of securely communicating between a Point-of-Sale (PoS) terminal and a payment card is provided. The method includes transmitting first data including a public key certificate of the PoS terminal from the PoS terminal to the payment card. The PoS terminal public key certificate is encrypted and signed by a certificate authority using a private key of the certificate authority. The first data is associated with a payment application for payment data. The method also includes receiving the first data from the PoS terminal at the payment card, and decrypting and validating the first data at the payment card using a public key certificate of the certificate authority. The method further includes transmitting second data including a public key certificate of the payment card from the payment card to the PoS terminal. The second data is transmitted after the first data is decrypted and validated by the payment card. The payment card public key certificate is encrypted and signed by the certificate authority using the private key of the certificate authority. The method also includes receiving the second data at the PoS terminal from the payment card, and decrypting and validating the second data received from the payment card at the PoS terminal using the public key certificate of the certificate authority. The method includes signing, at the PoS terminal, payment data with a private key of the PoS terminal to create a signature. The payment data is associated with the payment application. The method additionally includes encrypting the payment data and the signature at the PoS terminal with the payment card public key certificate, transmitting the encrypted payment data and the encrypted signature to the payment card, and decrypting the payment data and the signature at the payment card using a private key of the payment card corresponding to the payment card public key certificate.

In one or more embodiments, a method of securely communicating between a Point-of-Sale (PoS) terminal and a payment card is provided. The method includes transmitting first data including a public key certificate of the payment card from the payment card to the PoS terminal. The payment card public key certificate is encrypted and signed by a certificate authority using a private key of the certificate authority. The first data is associated with a payment application for payment data. The method also includes receiving the first data from the payment card at the PoS terminal, and decrypting and validating the first data at the PoS terminal using a public key certificate of the certificate authority. The method additionally includes transmitting second data including a public key certificate of the PoS terminal from the PoS terminal to the payment card. The second data is transmitted after the first data is decrypted and validated by the PoS terminal. The PoS terminal public key certificate is encrypted and signed by the certificate authority using the private key of the certificate authority. The method further includes receiving the second data at the payment card from the PoS terminal, and decrypting and validating the second data received from the PoS terminal at the payment card using the public key certificate of the certificate authority. The method includes signing, at the payment card, payment data with a private key of the payment card to create a signature. The payment data is associated with the payment application. The method also includes encrypting the payment data and the signature at the payment card with the PoS terminal public key certificate, transmitting the encrypted payment data and the encrypted signature to the PoS terminal, and decrypting the payment data and the signature at the PoS terminal using a private key of the PoS terminal corresponding to the PoS terminal public key certificate.

### BRIEF DESCRIPTION OF THE DRAWINGS

Other objects and advantages of the present embodiments will become apparent from a study of the following specification when viewed in the light of the accompanying drawings, in which:

FIG. 1 is a schematic diagram of a payment card, an issuer and acquirer certificate authority, and a PoS terminal according to at least one embodiment; and

FIG. 2 is a schematic illustration of a transaction flow with a payment card, a PoS terminal, and an acquirer bank according to at least one embodiment;

### DETAILED DESCRIPTION OF THE INVENTION

Reference will now be made in detail to the preferred embodiments of the present invention, examples of which are illustrated in the accompanying drawings, wherein like reference numerals refer to like elements throughout.

### Asymmetric Encryption and PKI

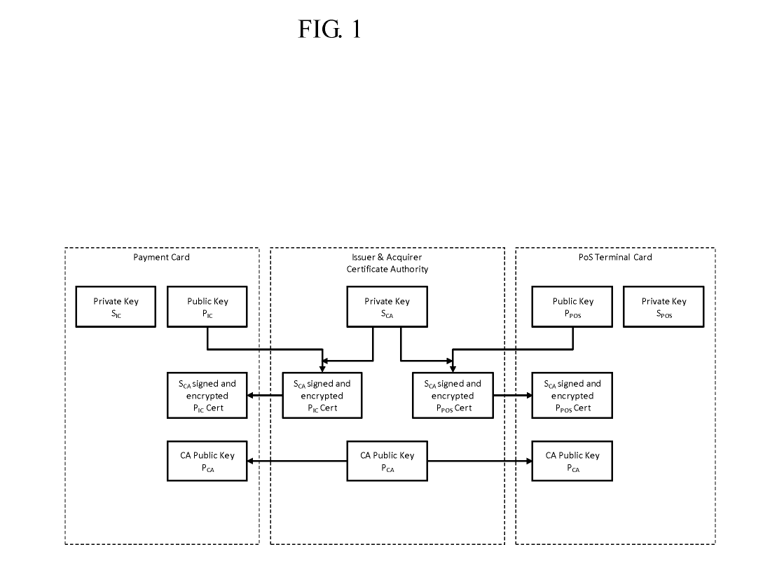

Turning now to FIG. 1, a schematic diagram illustrates a system including a payment card, a Certificate Authority (CA), and a PoS terminal card. The system is based on a PKI and requires that there is a trusted third party, such as a bank, mobile network operator (MNO) or a Certificate Authority (CA), who will perform certain security related operations for the payment card and for the PoS terminal.

The CA will enable and ensure a chain of trust using strong security methods and security certificates as described in typical PKI solution well known to a person skilled in the art.

The system consists on a PoS terminal which has at least one processor and program memory with at least one application program and the program can process at least one type of payment card transactions. The PoS terminal and the smart payment card will communicate between each other to determine which payment card application shall be used.

### Security Key Management

The PoS terminal has secure memory storage where it holds its secret or private encryption key and a public encryption key and a security certificate containing its public key which is signed and encrypted by the CA using its private key. These security keys can be generated by the PoS terminal or a smart card with a PoS terminal software, and secured certificates can be delivered to the PoS terminal memory and at the smart card memory at the time of manufacturing or at a later time if there is a secure method available to do so.

### Selection of Payment Application

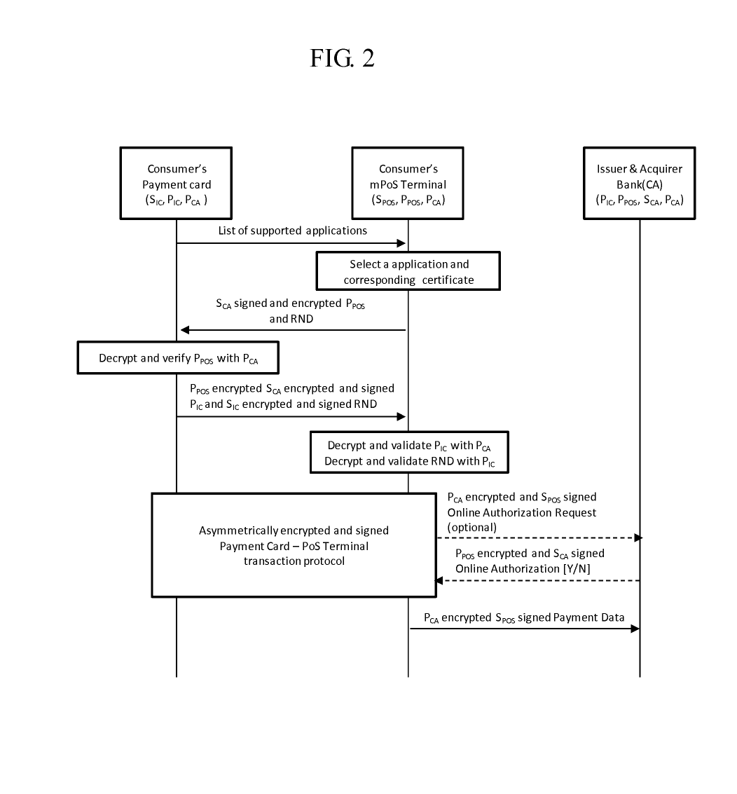

FIG. 2 illustrates a schematic illustration of a transaction flow with a payment card and a PoS terminal, and optionally with an acquirer bank according to at least one embodiment. When the communication between the payment card and the PoS terminal is established, the payment card will send a list of payment applications which it is capable to support and process. The list can be numbers or text or binary data. The list includes priority information for each supported payment application.

This list can be in clear text format or in a binary format without any specific encryption, because it does not contain any sensitive information about the payment card or its owner, but only a list of numbers corresponding to the payment applications the payment card supports. The application numbers can be for example 1 for VISA card, 2 for MasterCard and so on for each payment card scheme.

When the PoS terminal receives such list, it will compare the list with the payment applications it supports and then selects the highest priority payment application both parties are supporting.

### Secure Key Exchange

The PoS terminal will send a security certificate related to the selected payment application (Visa, Mastercard, etc.) to the payment card. The certificate contains the PoS terminal's public key which has been encrypted and signed by the corresponding CA using the CA's private key (S_{CA}). The PoS terminal can also send a non-predictable or a random number to the payment card.

The payment card will decrypt the data using the CA's Public Key certificate (P_{CA}) in its memory and validate the decrypted data using the CA's Public Key (P_{CA}).

The payment card will then send its own Public Key certificate (P_{IC}) encrypted and signed by the CA using a Private Key (S_{CA}), to the PoS terminal together with the non predictable or random number which is signs and encrypts using the card's own Private Key (S_{IC}).

The PoS terminal will use the CA's Public Key (P_{CA}) to decrypt and validate the data received from the payment card. The PoS terminal can decrypt the non-predictable number using the Cards Public Key (P_{IC}) it has received for validating the integrity of the communication and data received.

Once this operation has been completed successfully, both parties have securely received and are holding in addition to their own Private and Public Keys, also the other party's Public Key certificate.

While the secure key exchange has been shown and described as a transaction from the PoS terminal to the payment card, one of ordinary skill in the art would recognize that the secure key exchange can also be effected with the payment card as the transmitting party and the PoS terminal as the receiving party.

### Secure Transaction

The secure transaction may consist of one or several messages sent between the parties. The secure messaging can be either one directional or bi-directional. The principle of securing the information is using PKI method. In other words, the sending party will first sign the content with its own private key and then encrypt the content and the signature with the receiving party's public key. This ensure the content remains confidential and that only the recipient with its private key corresponding to the public key which was used to encrypt the data can decrypt it. Furthermore, the recipient can use the public key of the sender to verify that the message has not been altered after the sender signed it. This method is well known to a person skilled in the art.

One of ordinary skill in the art would recognize that the secure transaction can be effected with the payment card as the transmitting party and the PoS terminal as the receiving party or the PoS terminal as the transmitting party and the payment card as the receiving party.

This method can be enhanced to cover the transaction also from the PoS terminal to the CA or Acquiring bank. The PoS terminal can sign the payment data with its own Private Key and encrypt it with the CA's Public Key (PCA). In that case, the whole transaction could be secured flawlessly from end to end; from the payment card to the PoS terminal and to the Acquiring bank.

This invention is in particular suitable for a PoS terminal which are implemented fully or partially in a smart card, UICC card, a SIM card or in a mobile device, such as a mobile phone, a smart phone, a tablet computer, a laptop computer or a mobile PoS terminal, however it can be used in conjunction with any computing device with a secure element capable of storing security certificates and keys and to process cryptography operations.

Although the distance between a contactless card and a contactless reader can be only a few centimeters, the authentication of both parties, confidentiality and reliability are important factors especially when it comes to financial transactions used by hundreds of millions if not billions of people around the world, and it has a major effect on the trust of such system.

This method enables improved transaction security without any remarkable increase in cost.

Aspects of the present embodiment(s) can also be embodied as software configured to be used with a processor to cause the processor to perform operations, or can be embodied as hardware on one or more connected or unconnected devices.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A method of securely communicating between a Point-of-Sale (PoS) terminal and a payment card, the method comprising:
signing, at the PoS terminal, payment data with a private key of the PoS terminal to create a signature;
encrypting the payment data and the signature at the PoS terminal using a public key certificate of the payment card, the payment card public key certificate being encrypted and signed by a certificate authority using a private key of the certificate authority and being received at the PoS terminal from the payment card after a public key certificate of the PoS terminal is received from the PoS terminal and validated at the payment card, the PoS terminal public key certificate being encrypted and signed by the certificate authority using the private key of the certificate authority; and
transmitting the encrypted payment data and the encrypted signature to the payment card for decryption of the payment data and the signature at the payment card using a private key of the payment card corresponding to the payment card public key certificate.

2. The method according to claim 1, further comprising:
prior to signing and encrypting the payment data,
transmitting first data including the public key certificate of the PoS terminal to the payment card, the first data being associated with a payment application for the payment data, the payment application being selected at the PoS terminal;
receiving second data including the public key certificate of the payment card from the payment card at the PoS terminal, the second data being received at the PoS terminal from the payment card after the first data is decrypted and validated by the payment card; and
decrypting and validating the second data received from the payment card using a public key certificate of the certificate authority.

3. The method according to claim 1, further comprising:
receiving, at the PoS terminal, a first list of payment applications that the payment card is configured to support and process; and
comparing, at the PoS terminal, the first list of payment applications with a second list of payment applications that the PoS terminal is configured to support and process and selecting one of the payment applications.

4. The method according to claim 3, wherein the PoS terminal selects the payment application having a highest priority among payment applications that both the PoS terminal and the payment card are configured to support and process.

5. The method according to claim 2, wherein the first data is decrypted and validated by the payment card using a public key certificate of the certificate authority.

6. The method according to claim 1, wherein the first data includes a random number.

7. The method according to claim 6, wherein the second data includes the random number that is signed and encrypted using the payment card private key certificate.

8. The method according to claim 7, wherein the decrypting and validating the second data comprises decrypting the random number received from the payment card using the payment card public key certificate to validate the integrity of the communication between the PoS terminal and the payment card, and the received second data.

9. The method according to claim 1, wherein the PoS terminal is implemented in or in conjunction with a computing device.

10. A method of securely communicating between a Point-of-Sale (PoS) terminal and a payment card, the method comprising:
signing, at the payment card, payment data with a private key of the payment card to create a signature;
encrypting the payment data and the signature at the payment card using a public key certificate of the PoS terminal, the PoS terminal public key certificate being encrypted and signed by a certificate authority using a private key of the certificate authority and being received at the payment card from the PoS terminal card after a public key certificate of the payment card is received from the payment card and validated at the PoS terminal, the PoS terminal public key certificate being encrypted and signed by the certificate authority using the private key of the certificate authority; and
transmitting the encrypted payment data and the encrypted signature to the PoS terminal for decryption of the payment data and the signature at the PoS terminal using a private key of the PoS terminal corresponding to the PoS terminal public key certificate.

11. The method according to claim 10, further comprising:
prior to signing and encrypting the payment data,
transmitting first data including the public key certificate of the payment card from the payment card to the PoS terminal, the first data being associated with a payment application for the payment data;
receiving second data including the public key certificate of the payment card from the payment card at the PoS terminal, the second data being received at the PoS terminal from the payment card after the first data is decrypted and validated by the payment card; and
decrypting and validating the second data received from the payment card using a public key certificate of the certificate authority.

12. The method according to claim 11, wherein the transmitted second data is decrypted and validated using the certificate authority public key certificate.

13. The method according to claim 1, further comprising:
transmitting, from the payment card to the PoS terminal, a first list of payment applications that the payment card is configured to support and process for comparison of the first list of payment applications with a second list of payment applications that the PoS terminal is configured to support and process and selection of one of the payment applications, the payment data being associated with the selected payment application.

14. The method according to claim 13, wherein the payment application having a highest priority among payment applications that both the PoS terminal and the payment card are configured to support and process is selected.

15. The method according to claim 11, wherein the first data includes a random number.

16. The method according to claim 15, wherein the PoS terminal signs and encrypts the random number received from the payment card using the PoS terminal private key certificate,
the method further comprising receiving the signed and encrypted random number from the PoS terminal at the payment card.

17. The method according to claim 16, wherein the the random number received at the payment card is decrypted by the payment card using the PoS terminal public key certificate to validate the integrity of the communication between the PoS terminal and the payment card, and the received second data.

18. A method of securely communicating between a Point-of-Sale (PoS) terminal and a payment card, the method comprising:
transmitting first data including a public key certificate of the PoS terminal from the PoS terminal to the payment card, the PoS terminal public key certificate being encrypted and signed by a certificate authority using a private key of the certificate authority, the first data being associated with a payment application for payment data;
receiving the first data from the PoS terminal at the payment card;
decrypting and validating the first data at the payment card using a public key certificate of the certificate authority;
transmitting second data including a public key certificate of the payment card from the payment card to the PoS terminal, the second data being transmitted after the first data is decrypted and validated by the payment card, the payment card public key certificate being encrypted and signed by the certificate authority using the private key of the certificate authority;
receiving the second data at the PoS terminal from the payment card;
decrypting and validating the second data received from the payment card at the PoS terminal using the public key certificate of the certificate authority;
signing, at the PoS terminal, payment data with a private key of the PoS terminal to create a signature, the payment data being associated with the payment application;
encrypting the payment data and the signature at the PoS terminal with the payment card public key certificate;
transmitting the encrypted payment data and the encrypted signature to the payment card; and
decrypting the payment data and the signature at the payment card using a private key of the payment card corresponding to the payment card public key certificate.

19. A method of securely communicating between a Point-of-Sale (PoS) terminal and a payment card, the method comprising:
transmitting first data including a public key certificate of the payment card from the payment card to the PoS terminal, the payment card public key certificate being encrypted and signed by a certificate authority using a private key of the certificate authority, the first data being associated with a payment application for payment data;
receiving the first data from the payment card at the PoS terminal;
decrypting and validating the first data at the PoS terminal using a public key certificate of the certificate authority;
transmitting second data including a public key certificate of the PoS terminal from the PoS terminal to the payment card, the second data being transmitted after the first data is decrypted and validated by the PoS terminal, the PoS terminal public key certificate being encrypted and signed by the certificate authority using the private key of the certificate authority;
receiving the second data at the payment card from the PoS terminal;
decrypting and validating the second data received from the PoS terminal at the payment card using the public key certificate of the certificate authority;
signing, at the payment card, payment data with a private key of the payment card to create a signature, the payment data being associated with the payment application;
encrypting the payment data and the signature at the payment card with the PoS terminal public key certificate;
transmitting the encrypted payment data and the encrypted signature to the PoS terminal; and
decrypting the payment data and the signature at the PoS terminal using a private key of the PoS terminal corresponding to the PoS terminal public key certificate.
